(19) United States
(12) Patent Application Publication
(10) Pub. No.: US 2017/0089427 A1
(43) Pub. Date: Mar. 30, 2017

(54) DUAL CLUTCH TRANSMISSION FOR MOTOR VEHICLES

(71) Applicant: FORD GLOBAL TECHNOLOGIES, LLC, Dearborn, MI (US)

(72) Inventor: Johann KIRCHHOFFER, Cologne (DE)

(73) Assignee: FORD GLOBAL TECHNOLOGIES, LLC, Dearborn, MI (US)

(21) Appl. No.: 15/270,718

(22) Filed: Sep. 20, 2016

(30) Foreign Application Priority Data
Sep. 29, 2015 (DE) 10 2015 218 771.3

(51) Int. Cl. F16H 3/00; F16H 3/093

(52) U.S. Cl. CPC F16H 3/006; F16H 3/093

(57) ABSTRACT

A dual clutch transmission for motor vehicles includes first and second input shafts, two clutches selectively coupling the input shafts to the engine, two intermediate shafts arranged parallel to the input shafts, gearwheel pairs including fixed wheels and freely rotating wheels, of which a first gearwheel is arranged on one of the input shafts and a second gearwheel is arranged on one of the intermediate shafts, coupling devices selectively coupling the freely rotating wheels to the respective shaft, and a respective output gearwheel arranged on each of the two countershafts. A large number of ratios is made possible, without enlarging the dimensions of the transmission and the weight thereof, by virtue of the fact that one output gearwheel is a freely rotating wheel selectively coupled to the intermediate shaft thereof by a coupling device.

### CROSS-REFERENCE TO RELATED APPLICATIONS

This application claims foreign priority benefits under 35 U.S.C. §119(a)-(d) to DE 10 2015 218 771.3 filed Sep. 29, 2015, which is hereby incorporated by reference in its entirety.

### TECHNICAL FIELD

The invention relates to a dual clutch transmission for motor vehicles, having a first input shaft and a second input shaft, two clutches, preferably friction clutches, by means of which the first input shaft and the second input shaft can be coupled selectively to the engine, two intermediate shafts arranged parallel to the transmission input shafts, gearwheel pairs comprising fixed wheels and freely rotating wheels, of which a first gearwheel is arranged on one of the input shafts and a second gearwheel is arranged on one of the intermediate shafts, coupling devices, by means of which, relative to the respective shaft, the freely rotating wheels can be connected selectively thereto, and a respective output gearwheel arranged on each of the two countershafts.

### BACKGROUND

There is a concern in the automotive industry to adapt the operating state of the engine in an optimum manner to the current driving state of the motor vehicle in order to reduce emissions while driving. This can be accomplished, for example, by the transmission having a large number of ratios. In this case, shifting is performed in such a way that the engine speed is kept as low as possible, even at high driving speeds. Another aim is to minimize those masses which co-rotate under no load in order thereby to bring about a further reduction in emissions.

In conventional designs, a large number of ratios necessarily entail a relatively large number of transmission gearwheels and therefore a relatively large overall length, but this is not desirable in modern automotive engineering, and it also entails a relatively high weight of the transmission and relatively high power losses associated therewith.

Known transmissions of the type stated at the outset (WO 2012/084250 A1; DE 10 2013 216 387 A1) are therefore already progressing in the desired direction by providing the possibility for the power to flow both via a gearwheel stage associated with the first transmission input shaft and via a gearwheel stage associated with the second transmission input shaft.

In such dual clutch transmissions, the transmission input shafts are designed as an inner shaft and an outer shaft, wherein the inner shaft and the outer shaft can be driven selectively. The additionally selected ratios can then take a roundabout path, which passes via those gearwheels which are arranged on the respective non-driven transmission input shaft.

These known dual clutch transmissions, by means of which further ratios can be selected in addition to the existing gearwheel pairings and the ratios resulting therefrom, require hollow shaft arrangements for this purpose on the intermediate shafts and, to some extent also, on the transmission input shafts, on which hollow shaft arrangements at least two gearwheels in each case are arranged, wherein the hollow shafts co-rotate freely on the transmission input shafts and intermediate shafts but can be connected for conjoint rotation thereto when required.

The use of hollow shaft arrangements of this kind represents not only a high additional weight contribution but also leads to an increase in overall lengths or overall heights and to poorer efficiency of the transmission.

It is therefore the underlying object of the invention to create a dual clutch transmission which allows a large number of ratios without enlarging the dimensions of the transmission and the weight thereof.

### SUMMARY

According to the invention, this object is achieved by virtue of the fact that one output gearwheel on the intermediate shaft is embodied as a freely rotating wheel and can be connected for conjoint rotation to the intermediate shaft thereof by means of a coupling device.

An output gearwheel embodied as a fixed wheel can be arranged on one of the two intermediate shafts.

Preferably, however, output gearwheels embodied as freely rotating wheels are arranged on each of the two intermediate shafts, which gearwheels can be connected for conjoint rotation to the respective intermediate shaft by means of coupling devices. The two output gearwheels can have either the same diameter or different diameters.

When this measure is employed, a particularly large number of additional ratios, also referred to as winding path ratios, is possible in addition to the conventional number of ratios.

For transverse mounting of the transmission in a motor vehicle, a dual clutch transmission of this kind in which both output gearwheels mesh with a differential gearwheel is particularly suitable.

For longitudinal mounting, the dual clutch transmission can be designed in such a way that both output gearwheels mesh with at least one input gearwheel on a final drive shaft.

Dual clutch transmissions in which the two input shafts are embodied as an inner shaft and an outer shaft are particularly suitable for the application of the invention.

With the aid of this design, particularly space-saving construction is possible.

The coupling devices which are provided for the output gearwheels are expediently of single acting design and are each assigned to just one corresponding output gearwheel.

The power preferably flows via at least one gearwheel on the input shaft which is decoupled from the engine at any particular time. In this way, no additional gearwheels are required to produce further ratios.

In order to create additional possibilities of variation in a design of this kind, the power can flow via two gearwheels of different size on the decoupled input shaft, wherein the decoupled input shaft assumes the function of a countershaft.

The power flowing from the driven input shaft can furthermore pass via a first intermediate shaft, this intermediate shaft being connected in the manner of a countershaft. From there, the power flow can be transmitted to the non-driven input shaft and from the latter to the second intermediate shaft, wherein the output gearwheel arranged on the second intermediate shaft is coupled in a fixed manner thereto and transmits the power flow to the differential gearwheel or input wheel of a final drive shaft.

If the input shafts of the transmission are designed as an inner shaft and an outer shaft, it is possible, in the case of a particular shift operation, for the driven input shaft to be the inner shaft, wherein one gearwheel on the inner shaft meshes with one gearwheel on the first intermediate shaft, said gearwheel being selectively coupled by means of a coupling device. Another gearwheel on this first intermediate shaft, said gearwheel being selectively coupled by means of a coupling device, can then mesh with a transfer gearwheel on the idling outer shaft. The transfer gearwheel or some other fixed gearwheel on the decoupled outer input shaft can then mesh with a gearwheel coupled to the second intermediate shaft, while the output gearwheel on this second intermediate shaft is selectively coupled thereto by means of a coupling device. In this case, the output gearwheel seated on the first intermediate shaft should be decoupled and freely co-rotate.

In this design, the power flow from the non-driven outer shaft to the second intermediate shaft can take place via a different fixed gearwheel, which has a diameter which differs from the transfer gearwheel. A further ratio and/or a further variation of the speed-increasing or speed-reducing ratio is thereby possible.

As an alternative, it is, of course, also possible for the winding path ratios to be routed from the driven inner shaft initially to the second intermediate shaft and, from the latter, via the gearwheels of the idly co-rotating outer shaft, to the first intermediate shaft.

If, in the case of a particular shift operation, the driven input shaft is the outer shaft, one gearwheel on the outer shaft can mesh with one gearwheel on the first intermediate shaft, said gearwheel being selectively coupled by means of a coupling device. Another coupled gearwheel on this first intermediate shaft can then mesh with a transfer gearwheel on the decoupled inner input shaft, wherein the transfer gearwheel or another fixed gearwheel on the decoupled inner input shaft meshes with a gearwheel selectively coupled to the second intermediate shaft by means of a coupling device. The output gearwheel on this second intermediate shaft would then be selectively coupled thereto by means of its coupling device, while the output gearwheel seated on the first intermediate shaft is decoupled and freely co-rotates. In this design too, it is readily possible for the winding path ratios to be routed from the driven outer shaft initially to the second intermediate shaft and, from the latter, via the gearwheels on the decoupled inner shaft, to the first intermediate shaft.

With the aid of these described variants, it is possible to select various additional ratios.

In order to create additional possibilities of variation, the power flow from the non-driven inner shaft to the second intermediate shaft can take place via a gearwheel which has a diameter different from that of the transfer gearwheel, wherein the non-driven inner shaft is in practice connected as a countershaft.

A separate drive shaft having at least one gearwheel connected fixedly thereto is expediently provided for selecting a reverse gear, said gearwheel meshing both with a gearwheel on the driven input shaft and with a gearwheel on an intermediate shaft.

The invention is illustrated by way of example in the drawing and described below in detail with reference to the drawing, in which:

### BRIEF DESCRIPTION OF THE DRAWINGS

FIG. 1 shows a schematic view of a dual clutch transmission indicating a first possible selection when the first clutch is actuated,

FIG. 2 shows the same dual clutch transmission as that in FIG. 1 indicating a second possible selection when the first clutch is actuated,

FIG. 3 shows the same dual clutch transmission as that in FIG. 1 indicating a first possible selection when the second clutch is actuated, and

FIG. 4 shows the same dual clutch transmission as that in FIG. 1 indicating a second possible selection when the second clutch is actuated.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Two rotatable elements are fixedly coupled if they are constrained to rotate at the same speed about the same axis in all operating conditions. Rotatable elements, such as shafts or gearwheels, may be fixedly coupled, for example, by spline connections or machining from a common solid. In contrast, two rotatable elements are selectively coupled by a coupling device if they are constrained to rotate at the same speed about the same axis whenever the coupling device is fully engaged and are free to rotate at different speeds in some other operating condition. Coupling devices include, for example, dog clutches, synchronizers, and friction clutches. Some coupling devices, called single acting devices, have two positions and selectively couple a single gearwheel to a shaft. In one position, the gearwheel is constrained to rotate with the shaft. In the other position, the gearwheel freely co-rotates about the shaft. Other coupling devices, called double acting devices, have three positions and selectively couple two gearwheels to a shaft. In a central position, both gearwheels freely co-rotate about the shaft. In a left position, a left gearwheel is constrained to rotate with the shaft while a right gearwheel freely co-rotates about the shaft. In a right position, the right gearwheel is constrained to rotate with the shaft while the left gearwheel freely co-rotates about the shaft.

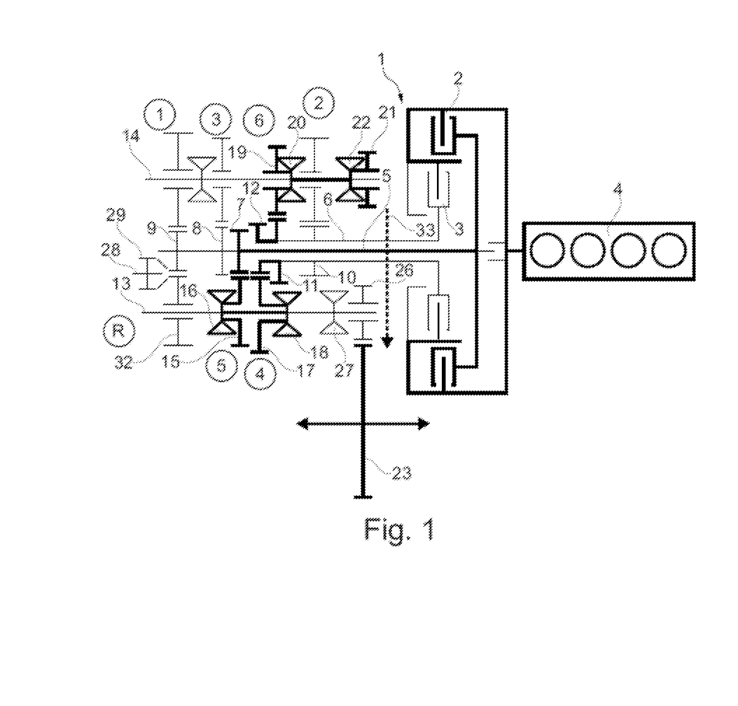

The transmission shown in FIGS. 1 to 4 is derived from a 6-speed transmission, in which the six ratio pairings and the reverse ratio are indicated by references 1 to 6 and R, in each case in a circle. Additional ratios are enabled by addition of coupling devices 22 and 27 that selectively couple/decouple output gearwheels 21 and 26 to/from intermediate shafts 14 and 13 respectively. In the individual figures, the power paths are highlighted by bold lines in the respective shift position, while the inactive transmission paths are shown as thin lines.

The dual clutch transmission 1 shown in FIG. 1 comprises two friction clutches 2 and 3, which transfer the power flow supplied by the engine 4 selectively and alternately to two input shafts. The input shafts are designed as an inner shaft 5 and an outer shaft 6, wherein the inner shaft 5 extends coaxially through the outer shaft 6.

Within the transmission housing (not shown in the drawing), the inner shaft 5 projects some way out of the outer shaft 6, wherein three gearwheels 7, 8, and 9 are fixedly coupled to the inner shaft 5 are arranged on the end of the inner shaft 5 which protrudes from the outer shaft 6. Three further gearwheels 10, 11, and 12 are likewise fixedly coupled to outer shaft 6.

Furthermore, two intermediate shafts 13 and 14 are provided, on which shafts gearwheels are arranged. The gearwheels arranged on the intermediate shafts 13, 14 are mounted rotatably on the intermediate shafts 13 and 14 and selectively coupled to the intermediate shafts 13 and 14 by coupling devices to select a desired ratio.

To illustrate the power flow within the transmission, the power path is, as already mentioned, illustrated in the drawing in bold solid lines from the engine 4 to the transmission output, allowing the power flow to be traced easily.

In the illustrative embodiment shown in FIG. 1, the drive is transmitted from the engine 4 via friction clutch 2 to the inner shaft 5, which is provided with the gearwheels 7, 8, and 9 arranged thereon.

In the illustrative embodiment shown, gearwheel 7 on the inner shaft 5 meshes with a gearwheel 15, which is arranged as a freely rotating wheel on the first intermediate shaft 13. Gearwheel 15 is selectively coupled to the first intermediate shaft 13 by coupling device 16, with the result that the first intermediate shaft 13 is thereby driven.

A further loosely guided gearwheel 17 is seated on the first intermediate shaft 13, said gearwheel being selectively coupled to the first intermediate shaft 13 by coupling device 18 and thereby likewise being driven.

Gearwheel 17 meshes with gearwheel 12, which is fixedly coupled to outer shaft 6, which is not connected to the engine 4 by its friction clutch and thus idly co-rotates. By virtue of the meshing engagement between the gearwheels 17 on the first intermediate shaft 13 and gearwheel 12 on the outer shaft 6, the outer shaft 6 is also driven, as are the other gearwheels arranged on this outer shaft 6. In the illustrative embodiment shown, gearwheel 11 on the outer shaft 6 meshes with a gearwheel 19, which is supported loosely on the second intermediate shaft 14 and selectively coupled to the latter by coupling device 20. The second intermediate shaft 14 is thereby also driven.

An output gearwheel 21 is supported loosely on intermediate shaft 14 and selectively coupled to the second intermediate shaft 14 by coupling device 22.

If the power path in FIG. 1 is traced by means of the bold solid lines, the coupled output gearwheel 21 is driven and transfers its torque to a differential gearwheel 23, which transfers its torque to the driven wheels of the respective vehicle via a differential (not shown specifically in the drawing).

In the drawing, the transmission axes are shown in a developed view, with the result that the meshing engagement of output gearwheel 21, which is seated on the second intermediate shaft 14, is illustrated schematically by means of a dashed arrow 33.

In a corresponding modification of the power path according to FIG. 1, it would also be possible for gearwheel 12, which is arranged on outer shaft 6, to mesh directly with a gearwheel coupled to the second intermediate shaft 14. In the illustrative embodiment under consideration, however, the path via a second meshing gearwheel 11 is chosen, with the result that the two gearwheels 11 and 12 on the outer shaft 6 act in the manner of a countershaft transmission, wherein the diameter of gearwheel 11 is greater than that of gearwheel 12.

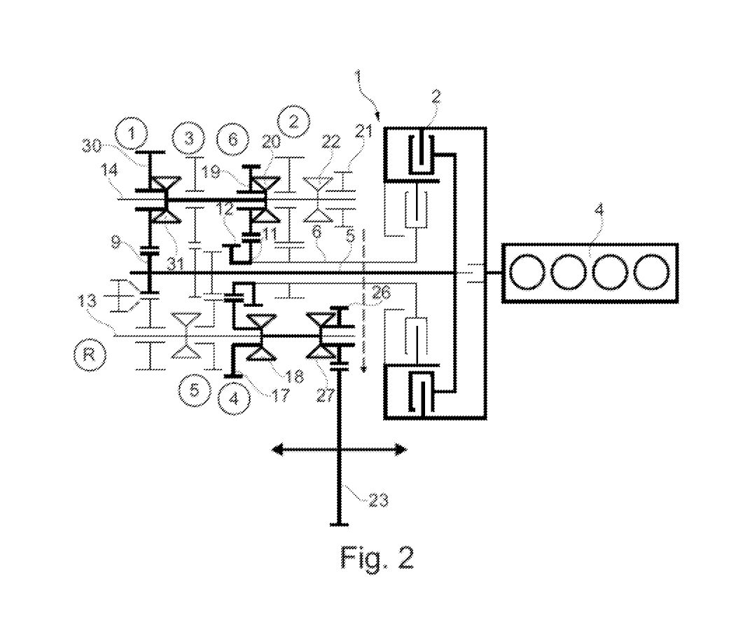

In the illustrative embodiment shown in FIG. 2, the engine 4 once again drives the inner shaft 5 via friction clutch 2, on which shaft gearwheel 9, which is arranged on the outside left, meshes with a gearwheel 30 on the second intermediate shaft 14. Gearwheel 30 is designed as a freely rotating wheel and, in the shift state under consideration, is selectively coupled to the second intermediate shaft 14 by coupling device 31.

In this way, gearwheel 19, which is seated on the second intermediate shaft 14, is selectively coupled to the second intermediate shaft 14 by coupling device 20 and meshes with gearwheel 11 on the outer shaft 6, which is thereby also driven. At the same time, gearwheel 12 on the outer shaft 6 also meshes with gearwheel 17 on the first intermediate shaft 13, which gearwheel is selectively coupled to the first intermediate shaft 13 by means of coupling device 18.

In the shift position shown in FIG. 2, output gearwheel 26, which is arranged on the first intermediate shaft 13, is selectively coupled to the first intermediate shaft 13 by coupling device 27 and transmits its torque to the differential gearwheel 23.

The output gearwheel 21 on the second intermediate shaft 14, which likewise meshes with the differential gearwheel 23, is decoupled in this shift position and merely freely co-rotates.

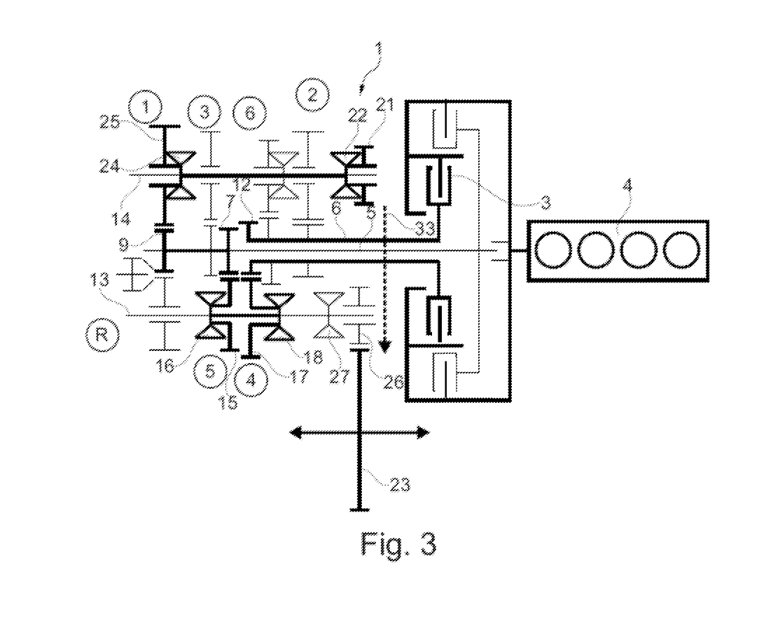

In the illustrative embodiment shown in FIG. 3, the power flows from the engine 4 to the outer shaft 6 via friction clutch 3.

In the shift state shown in FIG. 3, the gearwheel 12 fixedly coupled to outer shaft 6 meshes with the gearwheel 17 seated on the first intermediate shaft 13 and selectively coupled to the first intermediate shaft 13 by coupling device 18. The first intermediate shaft 13 is thereby driven.

At the same time, the further gearwheel 15 on intermediate shaft 13 is selectively coupled to intermediate shaft 13 by coupling device 16 and meshes with gearwheel 7 on the inner shaft 5, with the result that the latter is also driven.

If the power path is traced further along the bold solid lines, gearwheel 9, which is arranged on the outside left on the inner shaft 5 and meshes with gearwheel 25 on the second intermediate shaft 14, is also driven. In this shift state, gearwheel 25 is selectively coupled to the second intermediate shaft 14 by coupling device 24 and thus drives the second intermediate shaft 14.

In this shift state, output gearwheel 21, which is arranged on the second intermediate shaft 14, is selectively coupled to the second intermediate shaft 14 by coupling device 22 and thus transmits its torque to the differential gearwheel 23. The output gearwheel 26 seated on the second intermediate shaft 13 is decoupled and merely co-rotates freely. Thus, the power flow from the output gearwheel 21 on the second intermediate shaft to the differential gearwheel 23 is illustrated by the dashed arrow 33.

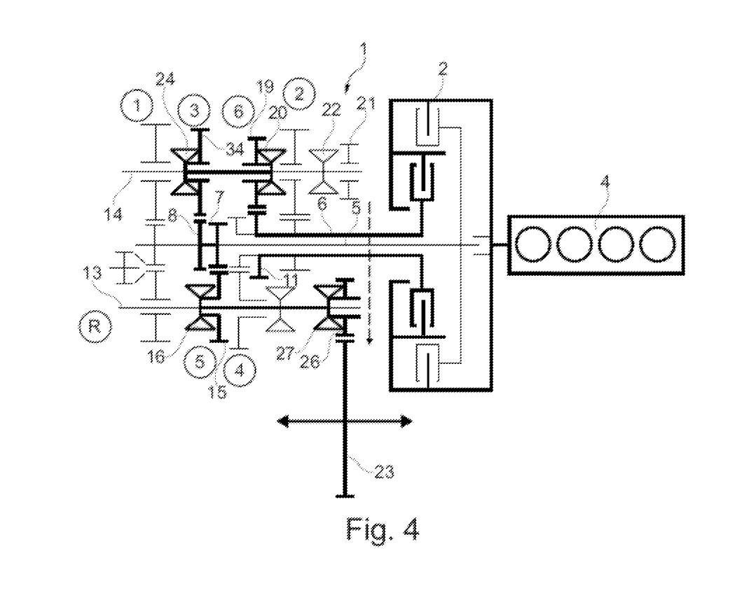

In the illustrative embodiment shown in FIG. 4, the power flow is once again transferred from the engine 4 to the outer shaft 6 via friction clutch 2.

Gearwheel 11, which is fixedly coupled to the outer shaft 6, meshes with gearwheel 19, which is seated on the second intermediate shaft 14 and is selectively coupled to the second intermediate shaft 14 by coupling device 20.

As a result, the second intermediate shaft 14 is driven. At the same time, gearwheel 34, which is selectively coupled to the intermediate shaft 14 via coupling device 24, is in meshing engagement with gearwheel 8, which is fixedly coupled to inner shaft 5, as a result of which the torque is transferred to inner shaft 5.

At the same time, gearwheel 7, which is likewise fixedly coupled to the inner shaft 5, is in meshing engagement with gearwheel 15 on the first intermediate shaft 13, wherein, in this shift position, gearwheel 15 is selectively coupled to the first intermediate shaft 13 by coupling device 16. In this way, the torque is transferred to the first intermediate shaft 13.

In this shift position, output gearwheel 26 is connected for conjoint rotation to the first intermediate shaft 13 coupling device 27, with the result that the torque is thereby transferred from output gearwheel 26 to the differential gearwheel 23.

Output gearwheel 21, which is seated on the second intermediate shaft 14 and likewise meshes with the differential gearwheel 23, co-rotates freely in the decoupled state.

In this shift example, the second intermediate shaft 14 thus acts as a countershaft and the inner shaft 5 likewise acts as a countershaft, with the result that an additional winding path ratio can thereby be selected.

Selection of further winding path ratios is readily possible, and therefore, as the four shift examples show, a very large number of different selections is possible. By virtue of the larger number of ratios thereby achieved, the steps from ratio to ratio can be reduced and the transfer of the power flow can be optimized. It is thereby possible not only to improve ride comfort but also to reduce emissions since the engine speed can be kept low and very largely uniform.

There is furthermore the advantage that at least some of the additionally available winding path ratios can be selected without an interruption in tractive effort and the overall spread of the transmission is increased.

In this transmission configuration, the reverse ratio can likewise be produced in a very unproblematic way.

As illustrated in FIG. 1, the power flow is transferred from the engine 4 to the inner shaft 5 via friction clutch 2. Gearwheel 9, which is seated on the outside left of the inner shaft 5, is thereby also driven. Here, a separate drive shaft 28 is used to produce the reverse ratio, on which drive shaft a gearwheel 29, which meshes both with gearwheel 9 on the inner shaft 5 and with gearwheel 32 on the first intermediate shaft 13, is seated. To select the reverse ratio, gearwheel 32 is selectively coupled to the first intermediate shaft by coupling device 16 and, from there, the torque can then be transferred directly via the coupled output gearwheel 26 on the first intermediate shaft 13 to the differential gearwheel 23 or, alternatively, to the differential gearwheel 23 via the roundabout path via the second intermediate shaft and the coupled output gearwheel 21 thereon. However, the power flow for the reverse ratio is not illustrated specifically in the four drawings.

When hollow shafts are involved in power transfer, separating forces on the gears push the hollow shaft against the shaft on which it is supported. Bearing must typically be employed to limit the resulting parasitic drag between the hollow shaft and the supporting shaft. These bearings increase cost, weight, and package space required. The arrangement of FIGS. 1-4 does not add any hollow shafts to the base arrangement. Output gearwheels 21 and 26 are loose gears that are supported by shafts 14 and 13 respectively. In any operating conditions in which an output gearwheel rotates at a different speed than the respective shaft, the output gearwheel is not involved in the power transfer. Consequently, no separating forces act on the output gearwheel to create parasitic drag at the interface with the shaft. Therefore, no additional bearings are required relative to the base 6 speed arrangement.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A dual clutch transmission for motor vehicles, comprising:
a first input shaft and a second input shaft;
two clutches configured to selectively couple the first input shaft and the second input shaft respectively to an engine;
two intermediate shafts arranged parallel to the transmission input shafts;
gearwheel pairs comprising fixed wheels and freely rotating wheels, of which a first gearwheel is arranged on one of the input shafts and a second gearwheel is arranged on one of the intermediate shafts;
coupling devices configured to selectively couple the freely rotating wheels to the respective shafts; and
two output gearwheels arranged on each of the two intermediate shafts wherein at least one of the output gearwheels is a freely rotating wheel selectively coupled to the respective intermediate shaft by a coupling device.

2. The dual clutch transmission of claim 1, wherein one of the output gearwheels is fixedly coupled to the respective intermediate shaft.

3. The dual clutch transmission of claim 1, wherein both of the output gearwheels are freely rotating wheels selectively coupled to the respective intermediate shafts by coupling devices.

4. The dual clutch transmission of claim 1, wherein both output gearwheels mesh with a differential gearwheel.

5. The dual clutch transmission of claim 1, wherein both output gearwheels mesh with at least one input gearwheel on a final drive shaft.

6. The dual clutch transmission of claim 1, wherein the two input shafts comprise an inner shaft and an outer shaft.

7. The dual clutch transmission of claim 1, wherein the coupling device provided for the output gearwheel is of single acting design.

8. The dual clutch transmission of claim 1, wherein power flows via one of the input shafts while it is decoupled from the engine.

9. The dual clutch transmission of claim 8, wherein the power flows via two gearwheels of different size on the decoupled input shaft.

10. The dual clutch transmission of claim 1, wherein:
power flows from the first input shaft to a first of the two intermediate shafts;
the power flows from the first of the two intermediate shafts to the second input shaft and from the second input shaft to a second of the two intermediate shafts; and
the power flows from the output gearwheel arranged on the second of the two intermediate shafts to a differential gearwheel.

11. The dual clutch transmission as claimed in claim 10, wherein:
the first input shaft is an inner shaft;
a first gearwheel on the first shaft meshes with a second gearwheel on the first of the two intermediate shafts, said second gearwheel being selectively coupled to the first of the two intermediate shafts by a first coupling device;
a third gearwheel on the first of the two intermediate shafts, said third gearwheel selectively coupled to the first of the two intermediate shafts by a second coupling device, meshes with a transfer gearwheel on the second input shaft;
the transfer gearwheel or some other fixed gearwheel on the second input shaft meshes with a fourth gearwheel on the second of the two intermediate shafts; and
the output gearwheel on the second of the two intermediate shafts is selectively coupled thereto by a third coupling device, while the output gearwheel on the first of the two intermediate shafts is decoupled therefrom.

12. The dual clutch transmission of claim 11, wherein the power flows from the second shaft to the second of the two intermediate shafts via a fixed gearwheel gearwheel having a diameter which differs from the transfer gearwheel.

13. The dual clutch transmission of claim 12, wherein
the power flows from the second input shaft to the second of the two intermediate shafts via a gearwheel which has a diameter different from that of the transfer gearwheel.

14. The dual clutch transmission of claim 10, wherein:
the first input shaft is an outer shaft;
a first gearwheel on the first input shaft meshes with a second gearwheel on the first of the two intermediate shafts, said second gearwheel being selectively coupled by a first coupling device;
a third gearwheel on the first of the two intermediate shafts meshes with a transfer gearwheel on the second input shaft;
the transfer gearwheel or another fixed gearwheel on the second input shaft meshes with a fourth gearwheel selectively coupled to the second of the two intermediate shafts by of a second coupling device; and
the output gearwheel on the second of the two intermediate shafts is selectively coupled thereto by means of its coupling device, while the output gearwheel on the first of the two intermediate shafts is decoupled therefrom.

15. The dual clutch transmission of claim 1, further comprising a separate shaft having at least one gearwheel fixedly coupled thereto for selecting a reverse gear, said gearwheel meshing both with a gearwheel on one of the input shafts and with a gearwheel on one of the intermediate shafts.

16. A transmission comprising:
two clutches configured to selectively couple an engine to first and second shafts;
third and fourth shafts;
a plurality of gearwheels and couplers configured to selectively establish power flow paths between the first and third shafts, the second and third shafts, and the second and fourth shafts; and
first and second output gearwheels supported on and selectively coupled to the third and fourth shafts respectively and meshing with a differential ring gear.

17. The transmission of claim 16 wherein the plurality of gearwheels and couples is further configured to establish power flow paths between the first and fourth shafts.

18. A transmission comprising:
first and second intermediate shafts;
a first output gearwheel coupled to the first intermediate shaft and meshing with a differential ring gear;
a second output gearwheel supported on the second intermediate shaft and meshing with the differential ring gear; and
a first output coupler configured to selectively couple the first output gearwheel to the first intermediate shaft.

19. The transmission of claim 18 further comprising a second output coupler configured to selectively couple the second output gearwheel to the second intermediate shaft.
